(19) United States
(12) Patent Application Publication
(10) Pub. No.: US 2024/0117160 A1
(43) Pub. Date: Apr. 11, 2024

(54) NON-SLIP OUTSOLE COMPOSITION INCLUDING COCONUT FIBER AND MANUFACTURING METHOD THEREOF

(71) Applicant: So Jin Jeong, Busan (KR)

(72) Inventor: So Jin Jeong, Busan (KR)

(21) Appl. No.: 17/961,531

(22) Filed: Oct. 6, 2022

(51) Int. Cl. C08L 9/00; A43B 13/02

(52) U.S. Cl. CPC C08L 9/00; A43B 13/026; C08L 2201/08; C08L 2205/03; C08L 2205/16; C08L 2312/00

(57) ABSTRACT

Proposed is a non-slip outsole composition containing coconut fiber. The composition contains 30 to 40 parts by weight of polybutadiene rubber, 20 to 30 parts by weight of elastomer, 15 to 20 parts by weight of filler, 20 to 30 parts by weight of coconut fiber, 0.1 to 1 part by weight of surfactant, 0.2 to 1 part by weight of a vulcanization accelerator, and 0.5 to 2 parts by weight of a cross-linking agent. Further proposed is a manufacturing method of a non-slip outsole containing coconut fiber. The method includes preparing the coconut fiber by separating a coconut into a cocopeat part and a coconut fiber part, blending a non-slip outsole composition by mixing the prepared coconut fiber with a rubber binder mixture, and producing the non-slip outsole through molding by injecting the non-slip outsole composition into a mold having a predetermined outsole shape, and finishing the non-slip outsole by cooling and aging the molded outsole.

### BACKGROUND OF THE INVENTION

### 1. Field of the Invention

The present disclosure relates to an outsole including coconut fibers contained in a coconut outer shell and a manufacturing method thereof.

### 2. Description of the Related Art

Shoes were developed to protect the wearer's feet, and in modern society, the perception of shoes is also changing a lot as the quality of life increases.

In the modern shoe industry, functional shoes specialized for various purposes such as hiking boots, sneakers, soccer shoes, tennis shoes, baseball shoes, golf shoes, and fashion shoes are developing according to user's needs.

Shoes are largely composed of an upper part protecting the instep and joint parts of the user and a sole part contacting the soles of the user's feet. In particular, in the case of the sole part, the impact may be transferred to the body during the walking process of the wearer, and when the sole part is heavy, the user may easily feel tired, and so the sole part should be buffer and absorb the impact and have a light structure.

In relation to this, in the case of shoes such as sports shoes, sneakers, and canvas shoes, appropriate elasticity and cushioning are required for the sole of the shoes in order to improve fit and easy-to-walk performance. The sole is foamed with various polymer binders such as a polyurethane binder, an ethylvinyl acetate binder, and synthetic rubber to form a cell structure, and in the case of the foamed sole, various components such as a surfactant, a plasticizer, and a foaming agent are added to the polymer binder, so that abrasion resistance and non-slip properties are determined according to the ratio of added components.

On the other hand, the structure of the sole part may be largely divided into an insole, a midsole, and an outsole. Among them, the outsole that is in direct contact with the ground is the part that is most sensitive to the condition of the ground and should be able to appropriately respond to the ground state during walking or running. In addition, when there is a lot of moisture on the road surface due to a rainy climate, a non-slip function is further required.

In the case of the non-slip function, there is a difference in the non-slip property required according to the type of shoes. For example, in the case of hiking boots, if the ground condition is irregular or if users mainly use the ground such as a mountain or valley, when the surface of the rock is often wet with moisture, insufficient outsole's non-slip function can cause serious damage to the human body by slippage. In addition, in the case of a workplace where the floor is always wet due to the characteristics of the place such as a ship, the non-slip function is an essential function.

In this regard, Korea Patent No. 10-1740347 relates to a shoe sole member made by recycling coffee grounds and a method of manufacturing the same. In the method of manufacturing shoe sole member, according to the patent, coffee grounds obtained through hydrolysis are dried, pulverized, and powdered to mix with a binder to form a shoe sole. More specifically, in the case of the above patent, hydrolysis further refines the coffee grounds, transforms them into a flexible form, and prevents agglomeration of the coffee grounds, thereby enhancing compatibility with the fluid binder. However, in the case of this method, there is a risk in the manufacturing process by putting coffee grounds into a strongly acidic solution to proceed with hydrolysis. In addition, even if the washing process is included, strong acids and strong bases are not completely removed, which can irritate the wearer's skin and cause harm to the human body. In addition, in the case of the hydrolysis process, there is a problem that considerable time and cost are required.

To solve this problem, Korea Patent No. 10-2117196 discloses that coffee oil is extracted by thermally pressing the collected coffee grounds, and the remained coffee grounds are dried and pulverized and mixed with a polymer resin to manufacture a shoe sole. In the case of the above method, using the coffee grounds is environmentally friendly, and there is no problem harmful to the wearer's body, but since the non-slip function of the shoes deteriorates as oil is included in the composition, the use of the shoes is limited.

### LITERATURES OF THE RELATED ART

### Patent Literatures

(Patent Literature 1) Korea Patent No. 10-1740347
(Patent Literature 2) Korea Patent No. 10-2117196

### SUMMARY OF THE INVENTION

Therefore, a technical solution of the present disclosure is to provide a non-slip outsole composition including coconut fiber that is environmentally friendly and does not cause chemical irritation to the user, as well as excellent aesthetics and non-slip performance applicable to fashion shoes such as sneakers.

In addition, another technical solution of the present disclosure is to provide a method of manufacturing a non-slip outsole, including coconut fiber.

In order to solve the above technical problem, the present disclosure provides a non-slip outsole composition containing coconut fiber, the composition including: 30 to 40 parts by weight of polybutadiene rubber, 20 to 30 parts by weight of elastomer, 15 to 20 parts by weight of filler, 20 to 30 parts by weight of coconut fiber, 0.1 to 1 part by weight of surfactant, 0.2 to 1 part by weight of a vulcanization accelerator, and 0.5 to 2 parts by weight of a cross-linking agent.

Preferably, the coconut fiber has a length in a range of 4 to 6 mm and is evenly dispersed/mixed in the outsole to have excellent non-slip properties.

Preferably, the coconut fiber further includes 0.1 to 1 part by weight of a UV block agent and 0.1 to 1 part by weight of an anti-aging agent.

In order to solve the other technical problem, the present disclosure provides a method of manufacturing a non-slip outsole composition containing coconut fiber, the method including: preparing the coconut fiber for removing and pulverizing foreign substances by separating a coconut into a cocopeat part and a coconut fiber part; blending a non-slip outsole composition by mixing the prepared coconut fiber and a rubber binder mixture; producing an outsole through a molding process by injecting the outsole composition into a mold having a predetermined outsole shape; and subjecting the outsole to finishing by cooling and aging the outsole.

Preferably, the blending of the outsole composition includes dispersing in a temperature range of 60° C. to 80° C.

The non-slip outsole composition, including coconut fiber, according to the present disclosure, has an effect of improving non-slip properties as the outsole is manufactured by inputting coconut fiber in butadiene rubber and elastomer. In addition, there is a design effect by forming a marbling pattern as the coconut fibers are evenly dispersed.

In addition, the coconut fiber used in the present disclosure has an environmentally friendly effect without skin irritation, even when directly exposed to the wearer's skin.

### BRIEF DESCRIPTION OF THE DRAWINGS

FIG. 1 is a schematic diagram showing a manufacturing process of a non-slip outsole according to an embodiment of the present disclosure;

FIG. 2 is a non-slip test result according to Test Example 1 of a non-slip outsole in Example 1 of the present disclosure;

FIG. 3 is a non-slip test result according to Test Example 1 of a non-slip outsole in Comparative Example 1 of the present disclosure;

FIG. 4 is a non-slip test result according to Test Example 1 of a non-slip outsole in Comparative Example 2 of the present disclosure;

FIG. 5 is a non-slip test result according to Test Example 1 of a non-slip outsole in Comparative Example 3 of the present disclosure; and

FIG. 6 is a test report result for Example 1 of the present disclosure.

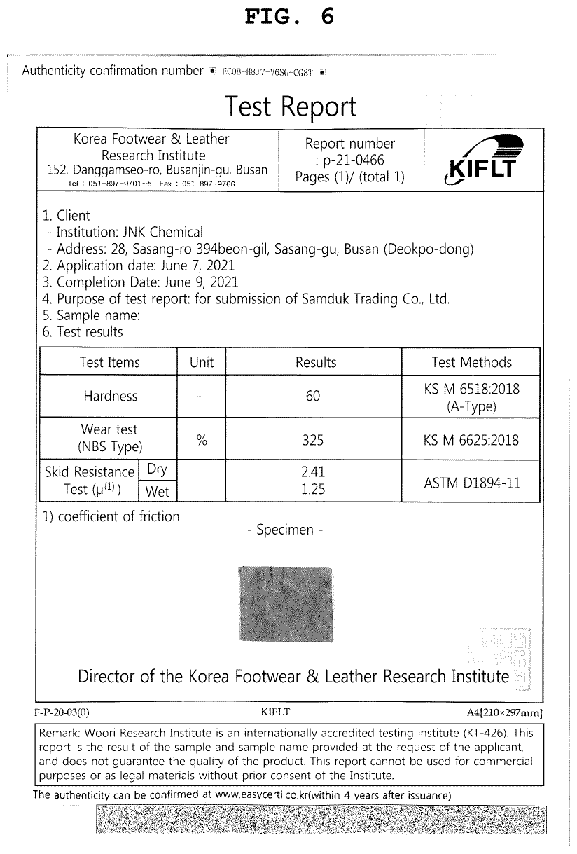

### DESCRIPTION OF THE PREFERRED EMBODIMENTS

Hereinafter, the present disclosure will be described in detail.

In one aspect, the present disclosure relates to an outsole composition containing coconut fiber, the composition including: 30 to 40 parts by weight of polybutadiene rubber, 20 to 30 parts by weight of elastomer, 15 to 20 parts by weight of filler, 15 to 20 parts by weight of coconut fiber, 0.1 to 0.5 part by weight of surfactant, 0.2 to 0.5 parts by weight of a vulcanization accelerator, and 0.5 to 1.5 parts by weight of a cross-linking agent.

In the present disclosure, the polybutadiene rubber is used for various purposes such as automobile tires, hoses, tubes, and electric wires in general homes and has excellent abrasion resistance, bending resistance, rebound elasticity, and cold resistance when used mixed with other rubbers.

In general, polybutadiene rubber preferably includes at least one catalyst among neodymium-based (Nd), cobalt-based (Co), nickel (Ni)-based, and titanium (Ti)-based catalysts according to the required physical properties, and in the present disclosure, a polybutadiene rubber using a nickel catalyst is used. More preferably, polybutadiene rubber having an elongation at break in a range of 500% to 520% and tensile strength at break in a range of 160 to 180 kgf/cm 2 is used. In addition, more preferably, the content of the polybutadiene rubber is preferably used in an amount of 30 to 40 parts by weight. When the polybutadiene rubber is included in an amount of less than 30 parts by weight, the processability, elasticity, and low-temperature characteristics of the shoe outsole are reduced, and when the polybutadiene rubber is included in an amount of more than 40 parts by weight, the durability of the shoes is reduced by reducing abrasion and cracking resistance instead of increasing elasticity.

The next included elastomer may improve nonslip properties by improving friction with the ground by an outsole and may also exhibit nonslip properties even when the ground is wet by moisture. In addition, the elastomer is characterized by easy processing due to easy shrinkage and processing fluidity. In addition, since the elastomer has a transparent color, it is possible to obtain the desired color through color mixing as necessary. However, for the addition of the above color, it is desirable not to impair the physical properties of the elastomer by mixing within a ratio of 5% by weight of the shoe outsole composition.

In addition, the elastomer is preferably included in 20 to parts by weight. When the elastomer is included in less than 20 parts by weight, the effect of improving the non-slip property on wet ground is insignificant, and when the elastomer is included in more than 30 parts by weight, the abrasion resistance property is reduced. Therefore, the elastomer preferably includes an appropriate amount of elastomer.

On the other hand, the filler has the effect of improving the abrasion rate and strength of the shoes-outsole and improving the safety of the outsole. As an example of the filler, it is preferable to use at least one selected from the group consisting of silica, carbon black, white carbon, calcium carbonate, silicate, talc, and mica, and most preferably, silica is used. In relation to the above, it is preferable to include 15 to 20 parts by weight of the filler. This is because when the filler is included in an amount of less than parts by weight, the abrasion rate of the outsole is reduced, and when the filler is included in an amount of more than 20 parts by weight, the elasticity of the shoes is reduced, so that the user may feel uncomfortable when worn for a long time.

Coconut fiber is the outer shell part of the coconut fruit, the fruit of the coconut tree. Recently, coconut fiber has been used as an eco-friendly flooring material for hiking trails and walking trails or as a natural material that provides acupressure when installed on barefoot trails. In relation to this, coconut fiber is an eco-friendly material with almost no chemical defects and has a delicate and thin fiber layer on the outside while a dense fiber layer of 2 to 5 cm on the inside. In the present disclosure, the coconut fiber was reprocessed, having a length of 4 to 6 mm, and used 20 to parts by weight. This is because when the coconut fiber is included in an amount of less than 20 parts by weight, the non-slip property is not improved. When the coconut fiber is included in an amount of more than 30 parts by weight, the performance of the butadiene rubber and elastomer is reduced. The coconut fiber is not evenly dispersed with the filler, and thus properly performing the function of the shoe outsole is difficult. In addition, when the length of the coconut fiber is less than 4 mm, the non-slip property is not improved only when the coconut fiber is included in excess, and when the length of the coconut fiber is more than 6 mm, the dispersibility with rubber decreases, which can increase the defect rate as the fiber is concentrated to one side.

On the other hand, in the present disclosure, the additive may include 0.1 to 1 part by weight of a surfactant, 0.2 to 1 part by weight of a vulcanization accelerator, and 0.5 to 2 parts by weight of a cross-linking agent and may include a dispersant known as other rubber additives within a range that does not damage physical properties of an outsole.

In the additive, it is preferable to use cobalt-based (Co) surfactant and nonylphenol (NPEs)-based surfactant as the surfactant. In relation to this, the surfactant has the property of improving the tearing properties of the outsole instead of delaying the curing rate as the molecular weight is increased. Therefore, in the present disclosure, the nonylphenol-based (NPEs) surfactant was included in an amount of 0.1 to less than 1 part by weight. At this time, when the surfactant is included in an amount of less than 0.1 parts by weight, the effect of tearing properties is insignificant, and when the surfactant is included in an amount of more than 1 part by weight, productivity and mechanical properties decrease due to the lengthening of the curing time, so it is preferable to be included within the amount range.

Next, the vulcanization accelerator is a representative organic rubber additive used together with the anti-aging agent and is added to the vulcanization process to impart elasticity to the raw rubber, thereby promoting the vulcanization rate and enhancing mechanical properties. Preferably, the vulcanization accelerator is included in an amount of 0.2 to 1 part by weight, but when the vulcanization accelerator is included in an amount of less than 0.2 part by weight, the vulcanization accelerating effect is insignificant, and when the vulcanization accelerator is included in an amount of more than 1 part by weight, the elasticity is increased instead of the abrasion rate is reduced, so adjustment is required.

As the cross-linking agent, dicumyl peroxide (DCP) may be used, and another general cross-linking agent such as PERKDOX may be used. More specifically, when the cross-linking agent is included in an amount of less than 0.5 parts by weight, there is a problem in that vulcanization does not occur or the vulcanization time is prolonged, resulting in a decrease in productivity, and when the cross-linking agent is included in an amount of more than 2 parts by weight, over-vulcanization occurs, the foaming rate is lowered, and physical properties are lowered due to the generation of defective bubbles, so it is preferable that the cross-linking agent is included in an appropriate composition.

In addition, a UV blocking agent blocks sunlight and prevents aging caused by UV rays, thereby extending the life of the product and improving color preservation. More preferably, it is preferable to use a nano-size blocking agent having an average particle diameter of 30 nm, and it is preferable to include 0.1 to 1 part by weight. This is because when a UV blocking agent is included in an amount of less than 0.1 part by weight, the UV blocking effect is insignificant, and when a UV blocking agent is included in an amount of more than 1 part by weight, a better UV blocking effect cannot be obtained.

In addition, the anti-aging agent functions to block a chain reaction in which oxygen or ozone reacts with rubber to cut polymer chains or promote rubber aging by cross-linking. There are mainly aromatic amine-based and phenolic-based types of anti-aging agent, and aromatic amine-based type is particularly effective in preventing daylight/ozone cracks, and is also effective in preventing curved cracks, and phenolic-based type is generally used as an antioxidant with a large molecular weight. Therefore, in the present disclosure, it is preferable to include 0.1 to 1 part by weight of the aromatic amine-based anti-aging agent. This is because, when the anti-aging agent is included in an amount of less than 0.1 part by weight, the rubber anti-aging function is weak, and when the anti-aging agent is included in an amount of more than 1 part by weight, mechanical properties are reduced.

On the other hand, it is preferable that the total ratio of the additive is included in an amount of less than 5 parts by weight because when the additive is included in an amount of more than 5 parts by weight, the acid resistance and chemical properties of the rubber are changed, thereby affecting the durability of the outsole.

On the other hand, as another aspect, the present disclosure relates to a method for manufacturing an outsole including coconut fiber. Specifically, the manufacturing method includes: preparing the coconut fiber 100 for removing and pulverizing foreign substances by separating a coconut into the cocopeat part (outside) and the coconut fiber part (inside); blending a non-slip outsole composition 200 by mixing the prepared coconut fiber and a rubber binder mixture; producing an outsole 300 a through molding process by injecting the outsole composition into a mold having a predetermined outsole shape; and subjecting the outsole to finishing by cooling and aging the outsole 400.

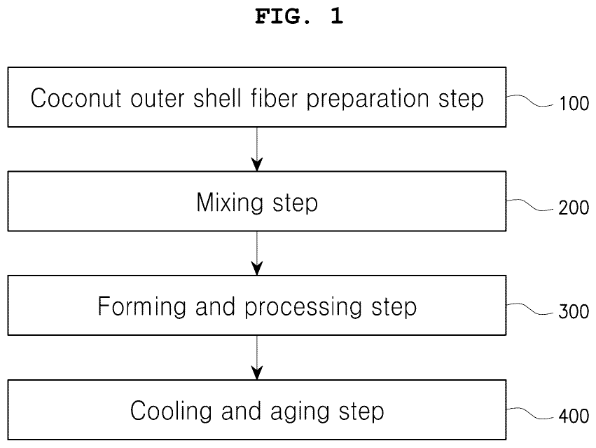

Hereinafter, it will be described in more detail with reference to FIG. 1.

The first process is the coconut fiber preparation step 100. More specifically, after the coconut is separated into a cocopeat part and a coconut fiber part, the separated coconut fiber part is washed with water, aged for 24 to 48 hours, and then water is removed through hot air drying and then subjected to a pulverizing process. In this case, the washing and aging process is for removing impurities from the coconut fiber, and thus the outsole defect rate can be minimized. In addition, the aging process is to facilitate pulverization so that the coconut fibers have similar size fibers. In relation to this, the coconut fiber is pulverized to a size of 4 to 6 mm and then sorted and separated through a sieve so that the coconut fiber is evenly dispersed/mixed without tangling with the polybutadiene rubber and elastomer in the process of compounding the outsole composition to be described later to have excellent non-slip properties.

The next process is mixing the prepared coconut fiber step 200 with a rubber binder mixture including polybutadiene rubber, elastomer, and additives to blend the outsole composition. More specifically, in the mixing process, additives and fillers are added to polybutadiene rubber and elastomer and kneaded for 10 to 15 minutes, and then the prepared coconut fiber is added and dispersed at a temperature of 60 to 80° C. for 10 to 20 minutes to mix the outsole composition. At this time, in the case of the dispersion temperature, when dispersed at a temperature of less than 60° C., the dispersibility of the pigment is lowered. When dispersed at a temperature of 80° C. or higher, the dispersibility is improved. Still as the solvent in the binder is evaporated, the viscosity rises and the production loss rate decreases, thereby decreasing the productivity and the yield of the composition. Therefore, in order to secure a yield of 95% to 99%, it is preferable to perform the dispersion in the above temperature range.

In relation to the dispersion, it is desirable to perform a mill dispersion or high-speed dispersion, which improves the uniform mixing of coconut fibers and the dispersibility of the pigment, thereby maximizing the efficiency of the pigment. In addition, the pigment and coconut fiber evenly dispersed in the rubber binder mixture are to produce an outsole with improved non-slip properties with a design added.

On the other hand, the dispersed outsole composition is preferably prepared in a sheet shape through a pressurization and cooling process at a temperature of 90° C. to 100° C. for smooth outsole production in the next molding process.

Next process is molding and processing the outsole step 300 in which the outsole composition produced by kneading is put into a mold, manufactured in an outsole form through a molding process, and finished with an edge. More specifically, molding is preferably performed by pressing for 5 to 10 minutes at a temperature of 150° C. to 160° C. This is because when the temperature is less than 150° C. or the time is less than 5 minutes, the outsole shape is molded indistinctly, and the defect rate is reduced, and when the temperature exceeds 160° C. or the time exceeds 10 minutes, the defect increases due to some heat.

The final process is an outsole finishing step 400 of cooling and aging the molded outsole. At this time, in the cooling process, it is preferable to cool the outsole at room temperature for at least 24 hours to prevent rapid shrinkage of the outsole, and more preferably, the cooled outsole is aged at room temperature for 150 hours or more so that the inside and outside are completely cured, thereby manufacturing an outsole having excellent abrasion resistance and elasticity.

Hereinafter, the present disclosure will be described in more detail through examples, but the present disclosure is not limited thereto.

### <Example 1> Manufacture of Outsole Including Coconut Fiber

A rubber mixture was prepared by kneading 38.3 parts by weight of polybutadiene rubber (LG Chem, BR-1208), 25.5 parts by weight of elastomer (ASAHI KASEI, ASAPRENE-303), 15.3 parts by weight of silica (EVONIK, SIPERNAT 238), 0.2 parts by weight of surfactant (ADEKA, PEP-8), 0.3 parts by weight of UV blocking agent (MIWON, MIRAMER M301), 0.1 parts by weight of anti-aging agent (JSC STERLITAMAK PETROCHEMICAL PLANT, BHT), 0.4 parts by weight of vulcanization accelerator (COSMOS CHEMICALS, COLINK 101-50D), and 1 part by weight of cross-linking agent (ARKEMA, LUPEROX 231XL40-SP E) for 15 minutes.

Next, 20 parts by weight of the prepared coconut fiber were added to the rubber mixture, and mill dispersion was performed at a temperature of 80° C. for 15 minutes. Next, the dispersed composition was produced in a sheet shape at a temperature of 100° C., put into a mold, and an outsole was manufactured through a press process at a temperature of 160° C. for 5 minutes, and then dried at room temperature for 7 days.

### <Comparative Examples 1-3> Manufacture of Outsole with Adjusted Coconut Fiber Content

In the composition of Example 1, only the coconut fiber content was adjusted to prepare an outsole under the same conditions. At this time, the adjusted coconut fiber content was replaced with silica.

More specific compositions and processes for Example 1 and

Comparative Examples 1 to 3 are Specified in Table 1 Below.

TABLE 1

| | | | Com- | Com- | Com- |
|---|---|---|---|---|---|
| Unit: parts by | | Example | parative | parative | parative |
| weight | | 1 | Example 1 | Example 2 | Example 3 |
| 1 | Polybutadiene | 38.3 | 38.3 | 38.3 | 38.3 |
| | rubber | | | | |
| 2 | Elastomer | 25.5 | 25.5 | 25.5 | 25.5 |
| 3 | Silica | 15.3 | 35.3 | 25.3 | 5.3 |
| 4 | Surfactant | 0.2 | 0.2 | 0.2 | 0.2 |
| 5 | UV blocking | 0.3 | 0.3 | 0.3 | 0.3 |
| | agent | | | | |
| 6 | Anti-aging agent | 0.1 | 0.1 | 0.1 | 0.1 |
| 7 | Vulcanization | 0.4 | 0.4 | 0.4 | 0.4 |
| | accelerator | | | | |
| 8 | Cross-linking | 1.0 | 1.0 | 1.0 | 1.0 |
| | agent | | | | |
| 9 | Coconut Fiber | 20.0 | — | 10.0 | 30.0 |

| | | |
|---|---|---|
| 10 | Process | Mixing for 15 minutes → Mill dispersion at |
| | | 80° C. for 15 minutes → Manufacture of sheet |
| | | shape at 100° C. → Press (mold) at 160° C. |
| | | for 5 minutes → Drying at room temperature |
| | | for 7 days |

### <Test Example 1> Non-Slip Property Test a

The angle at which slip occurs was measured for the outsole manufactured in Example 1 and Comparative Examples 1 to 3 through a non-slip resistance tester, and the stage used at this time was implemented on a glass plate.

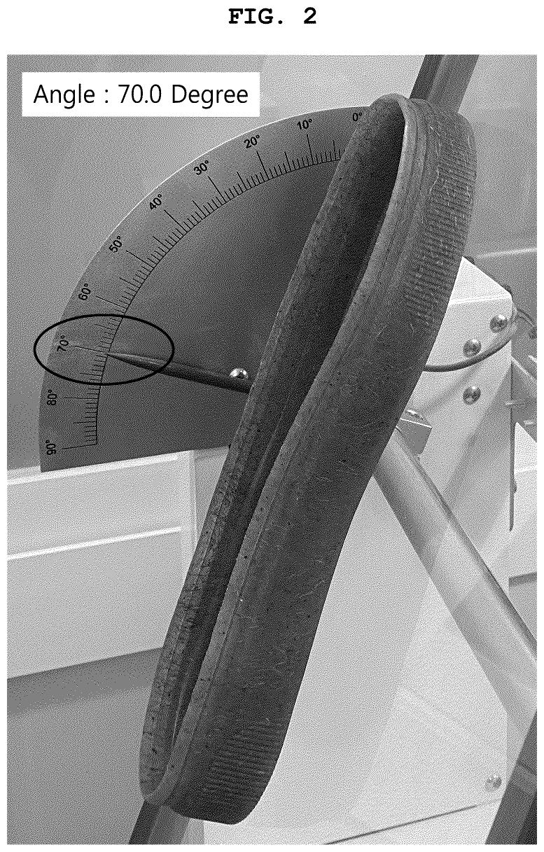

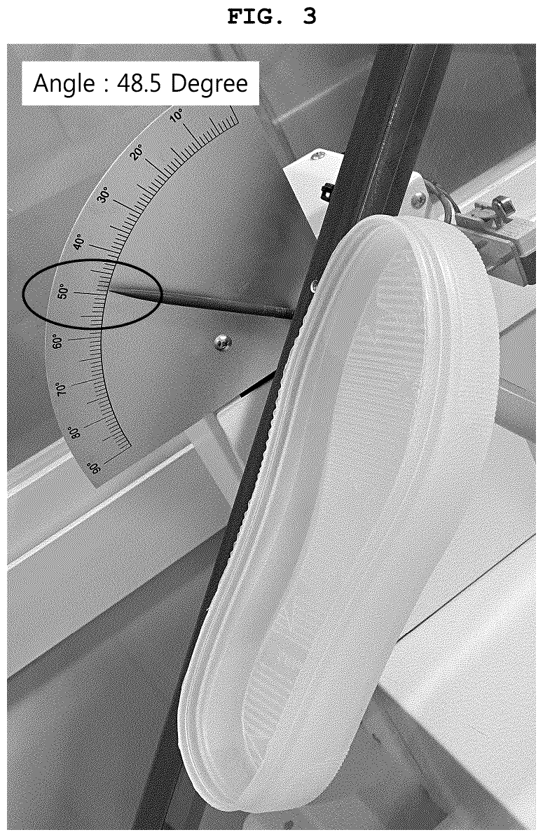

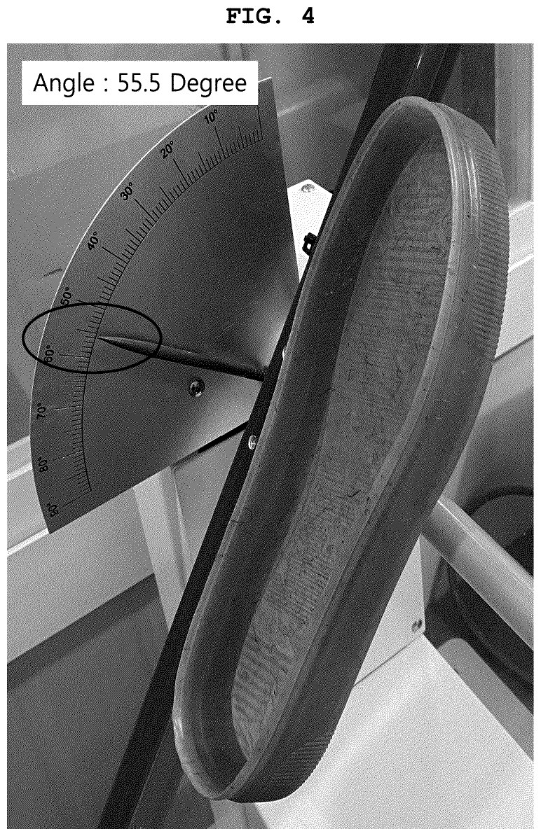

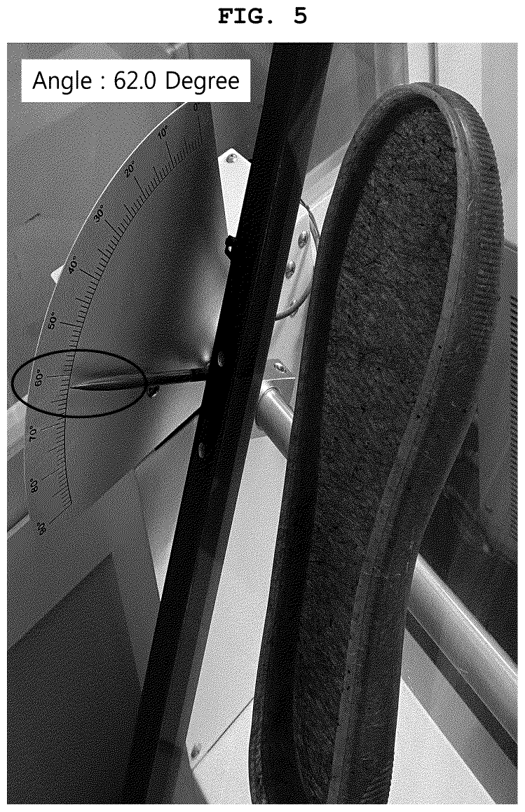

In relation to this, FIG. 2 shows the test results for Example 1, and FIGS. 3 to 5 show the test results for Comparative Examples 1 to 3. More specific test results are specified in Table 2 below.

TABLE 2

| | | Comparative | Comparative | Comparative |
|---|---|---|---|---|
| | Example 1 | Example 1 | Example 2 | Example 3 |
| Slip occurrence | 70 | 49 | 55.5 | 62 |
| angle | | | | |

As a result of the slip occurrence angle test, it was confirmed that the slippage of Example 1, including the coconut fiber, preferably occurred at about 70 degrees, as shown in FIG. 2, and the slippage occurred at about 48.5 degrees in Comparative Example 1 without the coconut fiber. In addition, in the case of Comparative Example 2, including a small amount of coconut fiber, it was confirmed that the slippage occurred at about 55.5 degrees, and in the case of Comparative Example 3 in which coconut fiber was included in excess, the slippage was exhibited at about 62.0 degrees, and when the coconut fiber was included in excess, the non-slip effect was rather reduced.

Therefore, as a result, it was confirmed that Example 1, including an appropriate amount of coconut fibers, exhibited the best non-slip properties.

### <Test Example 2> Non-Slip Property Test B

Based on Test Example 1, the outsoles prepared in Examples 1 and Comparative Examples 1 to 3 were measured for slip resistance values (dynamic friction coefficient) for dry and wet conditions according to ASTM D 1894-11. More specific test results are specified in Table 3 below.

TABLE 3

| | | Comparative | Comparative | Comparative |
|---|---|---|---|---|
| Unit: μ | Example 1 | Example 1 | Example 2 | Example 3 |
| Wet condition | 2.41 | 1.83 | 2.06 | 2.23 |
| Dry condition | 1.25 | 0.52 | 0.85 | 1.12 |

According to the test results, Example 1 showed results of 2.41 in the wet condition and 1.25 in the dry condition, while Comparative Example 1 showed 1.83 in the wet condition and 0.52 in the dry condition, and when a small amount of coconut fiber was included, the numerical value showed a slight improvement of 2.06 in the wet condition and 0.85 in the dry condition. However, in the case of Comparative Example 3, including an excessive amount of coconut fiber, it was confirmed that the value was 2.23 in the wet condition and 1.12 in the dry condition, which was lower than in Example 1, including an appropriate amount of coconut fiber, showing the same results as in Test Example 1.

Therefore, it was confirmed that the slip resistance had an effect of increasing in wet and dry conditions as the coconut fiber was adjusted to an appropriate amount.

### <Test Example 3> Hardness Test

The hardness values of the outsoles manufactured in Example 1 and Comparative Examples 1 to 3 were measured based on KS M 6518:2018 (A Type). More specific test results are specified in Table 4 below.

TABLE 4

| | | Comparative | Comparative | Comparative |
|---|---|---|---|---|
| Unit: — | Example 1 | Example 1 | Example 2 | Example 3 |
| Hardness | 60 | 63 | 62 | 57 |

According to the test results, Example 1 had a hardness of 60, Comparative Example 1, not including coconut fiber, had a value of 63, and Comparative Example 2, including a trace amount of coconut fiber, had a hardness of 62. On the other hand, in the case of Comparative Example 3, including an excessive amount of coconut fiber, it was confirmed that the hardness was rapidly decreased.

As a result, it was confirmed that the hardness of the outsole did not significantly decrease by adjusting the appropriate amount of coconut fiber.

### <Test Example 4> Abrasion Resistance Test

The abrasion resistance values of the outsoles manufactured in Example 1 and Comparative Examples 1 to 3 were measured based on KS M 6625:2018. More specific test results are specified in Table 5 below.

TABLE 5

| | | Comparative | Comparative | Comparative |
|---|---|---|---|---|
| Unit: % | Example 1 | Example 1 | Example 2 | Example 3 |
| Abrasion | 325 | 411 | 363 | 298 |
| resistance | | | | |

According to the test results, in the case of Example 1, it was confirmed that the abrasion resistance was 325% level, and in the case of Comparative Example 1, the value was 411%. In addition, in Comparative Example 2, including a trace amount of coconut fiber, the value was 363%, and in Comparative Example 3, including an excessive amount of coconut fiber, the value is less than 300%, confirming that it was not suitable as an outsole.

As described above in detail, a specific part of the present disclosure, various modifications, and variations will be possible without departing from the essential characteristics of the present disclosure for those of ordinary skilled in the art. Therefore, the embodiments disclosed in the present disclosure are not intended to limit the technical spirit of the present disclosure but to explain, and the scope of the technical spirit of the present disclosure is not limited by these embodiments. The protection scope of the present disclosure should be interpreted by the claims, and all technical ideas within the equivalent range should be interpreted as being included in the scope of the present disclosure.

What is claimed is:

1. A non-slip outsole composition containing coconut fiber, the composition comprising:
30 to 40 parts by weight of polybutadiene rubber;
to 30 parts by weight of elastomer;
to 20 parts by weight of filler; 20 to 30 parts by weight of coconut fiber;
0.1 to 1 part by weight of surfactant; 0.2 to 1 part by weight of a vulcanization accelerator; and
0.5 to 2 parts by weight of a cross-linking agent.

2. The composition of claim 1, wherein
the coconut fiber has a length in a range of 4 to 6 mm and is evenly dispersed/mixed in an outsole so that the outsole has excellent non-slip properties.

3. The composition of claim 1, wherein
the composition further comprises 0.1 to 1 part by weight of a UV blocking agent and 0.1 to 1 part by weight of an anti-aging agent.

4. A method of manufacturing a non-slip outsole comprising coconut fiber, the method comprising:
preparing the coconut fiber for removing and pulverizing foreign substances by separating a coconut into a cocopeat part and a coconut fiber part;
blending a non-slip outsole composition by mixing the prepared coconut fiber and a rubber binder mixture;
producing an outsole through a molding process by injecting the outsole composition into a mold having a predetermined outsole shape; and
subjecting the outsole to finishing by cooling and aging the outsole.

5. The method of claim 4, wherein
blending of the outsole composition comprises dispersing in a temperature range of 60° C. to 80° C.
